(19) United States
(12) Patent Application Publication
(10) Pub. No.: US 2012/0030902 A1
(43) Pub. Date: Feb. 9, 2012

(54) DOOR SAFETY DEVICE

(76) Inventor: Donald F. DUFEK, Phoenix, AZ (US)

(21) Appl. No.: 12/852,607

(22) Filed: Aug. 9, 2010

(51) Int. Cl. E05F 5/08; B23P 17/00

(52) U.S. Cl. 16/85; 29/428

(57) ABSTRACT

Various device and method embodiments for preventing the closing of a door are provided. The device includes a pivot structure and a cushion structure. The pivot structure is connected to the cushion structure. The pivot structure is capable of connecting to a door, wherein the pivot structure is adapted to position the cushion structure in a manner to prevent the door from substantially closing. Related device and method embodiments are disclosed and provide additional advantages.

### BACKGROUND OF THE INVENTION

1. Field of the Invention

The present invention relates in general to a safety device, and more particularly to a door safety device for preventing a door from closing.

2. Description of the Prior Art

Safety devices are utilized in today's society to prevent injuries. Specifically, door safety devices assist in preventing a door from being closed and injuring a body part, particularly hands and fingers. Many safety devices are placed over a door hinge without being connected to prevent the closure of a door while other devices are permanently attached to a doors edge.

### SUMMARY OF THE INVENTION

The focus of a door safety device should provide protection to the handle, as well as the hinge side of the door, regardless of the side on which the device is attached. The door safety devices should allow for the safety device to remain connected to the door when the door is closed, or in the alternative, provide an option of easily removing the door safety device without complicated mounting features. A safety device with such features should be relatively inexpensive without compromising safety. Not requiring the user to remove the device, when desiring to close the door, servers the consumer's needs for energy saving features, home security, privacy, and other purposes. The safety device should provide the consumer a low cost solution with the option to semi-permanently or permanently connect the device to a door.

In view of the foregoing, a need exists for a door safety device, capable of being semi-permanently or permanently attached to a door, to prevent a door from closing on a body part while offering the ability to close the door without the device being activated. Accordingly, various device and method embodiments for a door safety device are provided.

In one exemplary embodiment, by way of example only, is a device for preventing the closing of a door. A cushion structure and a pivot structure are disclosed. The door safety device includes a cushion structure that is connected to the pivot structure; the pivot structure is capable of connecting to the door. The pivot structure positions the cushion structure in a manner to prevent the door from substantially closing.

Related device and method embodiments are also disclosed and provide additional advantages.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A illustrates an exemplary pivot structure and cushion structure according to the present invention from a top view;

FIG. 1B illustrates an exemplary pivot structure and cushion structure according to the present invention from a side view;

FIG. 2A illustrates an exemplary pivot structure and cushion structure according to the present invention from a front view;

FIG. 2B illustrates an exemplary pivot structure and cushion structure according to the present invention from a back view;

FIG. 2C illustrates an exemplary pivot structure according to the present invention from a back view;

FIG. 3A illustrates an exemplary pivot structure and a hinge with elongated member according to the present invention;

FIG. 3B illustrates an exemplary pivot structure with a connection piece according to the present invention from a top view and a three-dimensional view;

FIG. 4 illustrates several exemplary pivot structures and cushion structures attached together according to the present invention from a top view;

FIG. 5 illustrates several exemplary pivot structures and cushion structures attached together according to the present invention from a three dimensional back view;

FIG. 6A illustrates an exemplary pivot structures and cushion structures attached together and connected to the door according to the present invention from a three-dimensional side view;

FIG. 6B illustrates an exemplary pivot structures and cushion structures attached together and connected to the door according to the present invention from a three-dimensional side view; and

FIG. 7 illustrates a flow chart diagram of an exemplary method for manufacturing a door device for preventing the closing of a door.

### DETAILED DESCRIPTION OF THE DRAWINGS

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The schematic flow chart diagrams included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

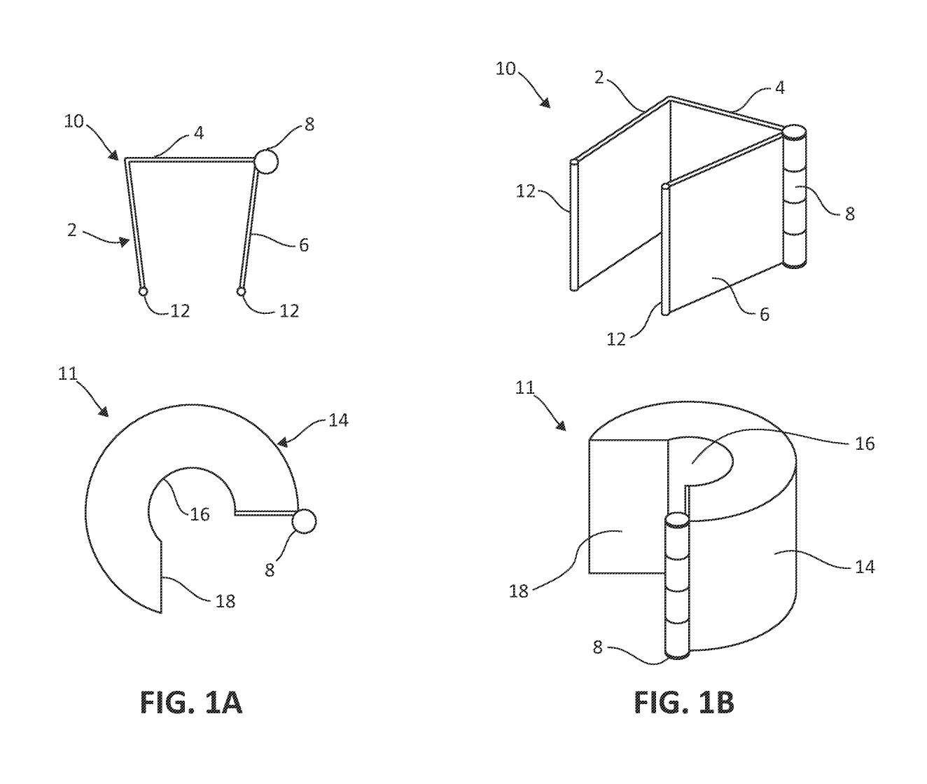

Referring to FIGS. 1A and 1B collectively, with FIG. 1A showing a top view and FIG. 1B demonstrating a side view, is a depiction of one example of a pivot structure 10 and cushion structure 11. The pivot structure 10 may be composed of steel, iron, a high-strength, lightweight alloy material, any metallic material, polyvinyl chloride (PVC) material, carbon fiber, a polyurethane material, a joint metallic and polyurethane material, or any other material or combination of materials known in the art, which are suitable for such an application. The cushion structure 11 may be composed of dense foam, plastic, carbon fibers, polyurethane material, fibrous materials, rubber materials, or other material or combination of materials known in the art, which are suitable for such an application. The cushion structure 11 shape may be U-shaped, L-shaped, C-shaped, triangular, rectangular, square, pentagonal, hexagonal, heptagonal, octagonal, round, oval, heart-shaped, kidney-shaped, elliptical, egg-shaped, n-sided, or any other shape to best fit the type of door and style preference of the consumer. An internal or external weight lining of any type of substance, such as metal or plastic, may be utilized to provide structural integrity, additional strength to the cushion, or simply to enhance the aesthetics of the cushion structure 11.

Pivot structure 10 includes a hinge structure 8, viewed from the top view and side view. In one embodiment, the pivot structure 10 has three sides, a first side 2, a second side 4, and a third side 6. The three sides form a c-shape or u-shape mounting structure to attach to a door. Each of the pivot structure 10 sides may include a n-number of openings allowing for any type of pin, bolt, screw, nail, fastener, or other connective device known in the art, which are suitable for such an application, to be inserted into the openings and connect to the door. At the end of both the first side 2 and the third side 6 a protective device 12 may be attached to protect the surface of the door from being scratched or damaged. The protective device may be any type of rubber, plastic, foam, carbon fiber, polymer, fibrous substance, cloth, synthetic material, or any other type of protective device known in the art, which are suitable for such an application.

The pivot structure 10 may attach to the cushion structure 11 and a door 51 using both permanent and semi-permanent options, including, but not limited to screws, nails, pins, adhesive, tape, Velcro®, or other type adhesive devices known in the art, which are suitable for such an application. The pivot structure 10 may also be developed to be a mounting clamp, absent any openings in any of the three sides of the pivot structure 10, which may slide and grip onto the door. Any of these connecting options allows for the securing of the protective device 12 so as to connect to any type of door. For example, if the door is a glass door, using an adhesive or Velcro® option may provide a useful option. Alternatively, if the pivot structure requires a semi-permanent connection to the door for repeatedly mounting or removing the door safety device with ease, selecting the mounting clamp option where the device is securely attached by the flexible, rigid first side 2 and the third side 6, designed for clamping and gripping the door, provides another useful option.

In one embodiment, the hinge structure 8 may be a spring-loaded hinge implemented to set and release the pivot structure 10. The hinge structure 8 may be connected and joined directly to the corner of the first side 2 or third side 6 and then connecting with one of the ends of the second side 4. In the exemplary example, the hinge structure 8 is connected at the ends of the third side 6 and the end of the second side 4, where the two ends meet and form a corner. Additionally, the hinge structure 8 could easily be attached to any location on any of the three sides, if needed. Depending upon the way a door opens, either swinging to the outside or the inside, the hinge 8 is capable of being connected to the particular side of the pivot structure 10 to insure any useful option for positioning of the cushion structure 11. The hinge structure 8 may be one commonly known in the art allowing both the pivot structure 10 and the cushion structure 11 to pivotally move about the hinge structure 8.

In one embodiment, the cushion structure 11 may form a three dimensional c-shape or u-shape. In FIGS. 1A and 1B collectively, the cushion structure 11 forms a three dimensional c-shape. An outer surface 14 and an inner surface 16 is shown. A planar end 18 connects the outer surface 14 to the inner surface 16. The hinge structure 8 may connect to either corner end of the planar surface 18 or connect anywhere along the planar surface 18, as required by the type of door, cushion structure 11 design, and mounting requirements of the safety device for preventing the closing of the door. The hinge structure 8 may be attached to both the cushion structure 11 and the pivot structure 10. For example, as seen in FIGS. 1A and 1B collectively, the hinge structure 8 is connected to the corner of the pivot structure 10, where one of the ends of third side 6 connects to one the ends of the second side 4 forming a corner. The corner of either the first side 2 and the second side 4, or the corner of the third side 6 and the second side 4, may be rounded or squared with flexibility to bend and adjust according to the particular door for mounting the pivot structure 10 to the door. The hinge structure 8 is connected to the edge of the planar surface 18 where the planar surface 18 connects to the outer surface 14 of the cushion structure 11.

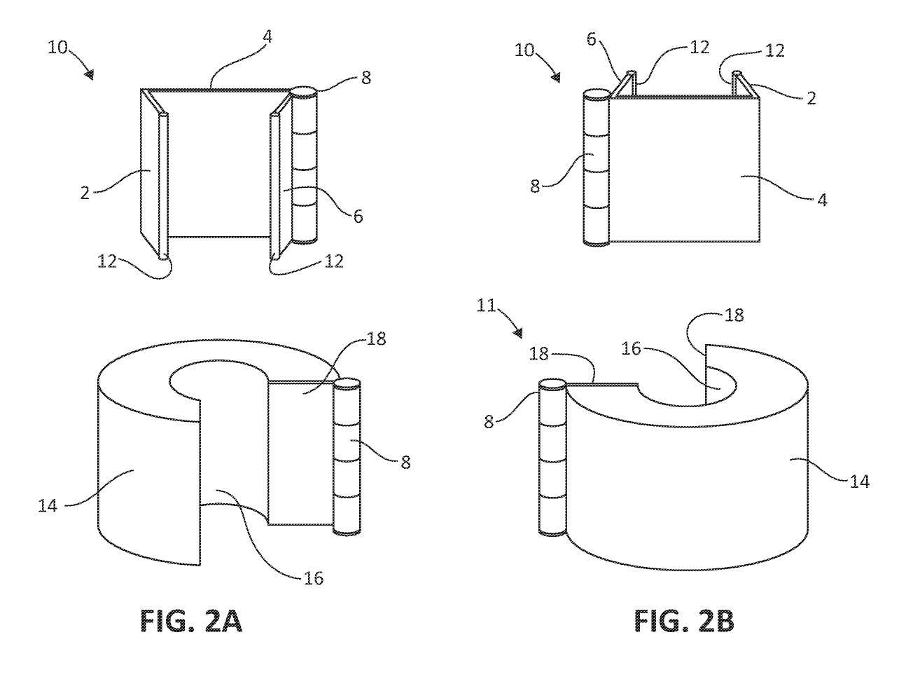

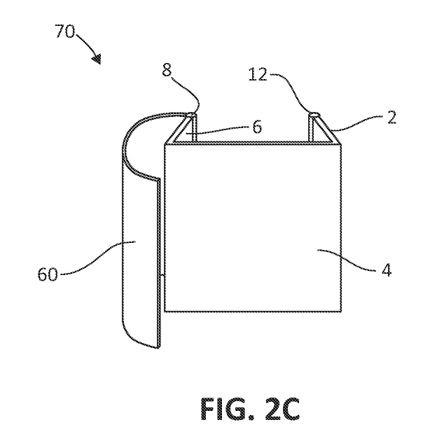

Turning to FIGS. 2A, 2B, and 2C collectively, one embodiment of a pivot structure 10 and 70 and cushion structure 11 is shown in a three dimensional view from the front view and the back view. In one embodiment, again the pivot structure 10 has three sides, a first side 2, a second side 4, and a third side 6. The three sides form a c-shape or u-shape mounting structure to attach to a door. The pivot structure 10 includes a hinge structure 8. The hinge structure 8 may be connected and joined directly to the corner of the first side 2 or third side 6 where the first side 2 or third side 6 connects to the second side 4. Additionally, the hinge structure may easily be attached to any location on any of the three sides, if needed. Depending upon the way a door opens, either swinging to the outside or the inside, the hinge structure 8 is capable of being connected to the particular side of the pivot structure 10 to insure any useful option for positioning of the cushion structure 11. The hinge structure 8 may be one commonly know in the art allowing both the pivot structure 10 and the cushion structure 11 to pivotally move about the hinge structure 8.

The cushion structure 11 may form a three dimensional c-shape or u-shape. In FIGS. 2A and 2B collectively, the cushion structure 11 forms a three dimensional C-shape structure. An outer surface 14 and an inner surface 16 are depicted. A planar surface 18 connects the outer surface 14 to the inner surface 16. The hinge structure 8 may connect to either corner end of the planar surface 18 or connect anywhere along the planar surface 18, as required by the type of door, cushion structure 11 design, and mounting requirements of the door safety device for preventing the closing of the door. The hinge structure 8 may be attached to both the cushion structure 11 and the pivot structure 10. For example, as seen in FIGS. 2A and 2B collectively, the hinge structure 8 is connected to corner of the pivot structure 10, where the third side 6 connects to the second side 4. The hinge structure 8 is connected to the edge of the planar surface 18 where it connects to the outer surface 14 of the cushion structure 11.

As depicted in FIG. 2C, the cushion structure 11 may form a three dimensional c-shape or u-shape. In one embodiment, the pivot structure 70 may be one single piece including a connection member 60 for connecting to the cushion structure 11. A connection member 60 may have two ends; a first end being connected to the end of either the first side 2 or the third side 6 and a second end for connecting to the cushion structure 11. Additionally, the hinge structure 8 may connect to the end of the first side 2 or third side 6 of the pivot structure 70 and the connection member be connected to the hinge structure 8. The connection member 60 may be designed in any particular shape according to the door or doorframe the pivot structure 70 will attach to or protect. In the depicted example, the connection piece 60 is elliptical or parabolic shape with the first end connected to the end of the third side 6. The second end of the connection member 60 is positioned so that a cushion structure may connect to the connection member 60. An outer surface 14 and an inner surface 16 are depicted for the cushion structure 11. A planar end 18 connects the outer surface 14 to the inner surface 16. The hinge structure 8 may connect to either corner end of the planar surface 18 or connect anywhere along the planar surface 18, as required by the type of door, cushion structure 11 may be connected to the connection piece 60. The connection piece 60, may flex, bend, or rotate away from the third side 6. The connection piece 60 maintains a constant pressure or spring like characteristic. For example, when the pivot structure 70 is attached to a door and the door is closed, the connection piece 60, which is connected to the cushion structure 11, rotates backwards, or away from the third side 6. The connection piece 60 maintains a constant pressure on the cushion structure 11. Upon the opening of the door, the spring like pressure in the connection piece 60, releases or springs the cushion structure 11 into a position to prevent the door, which the pivot structure is attached, from closing leaving a space between the door and another door or door frame.

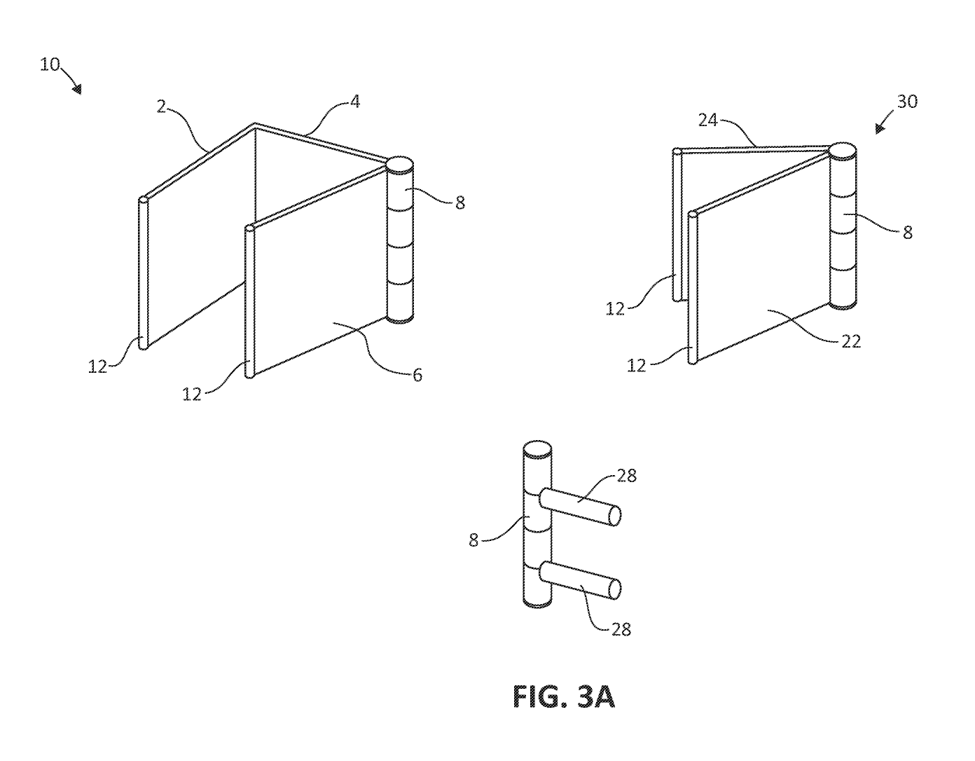

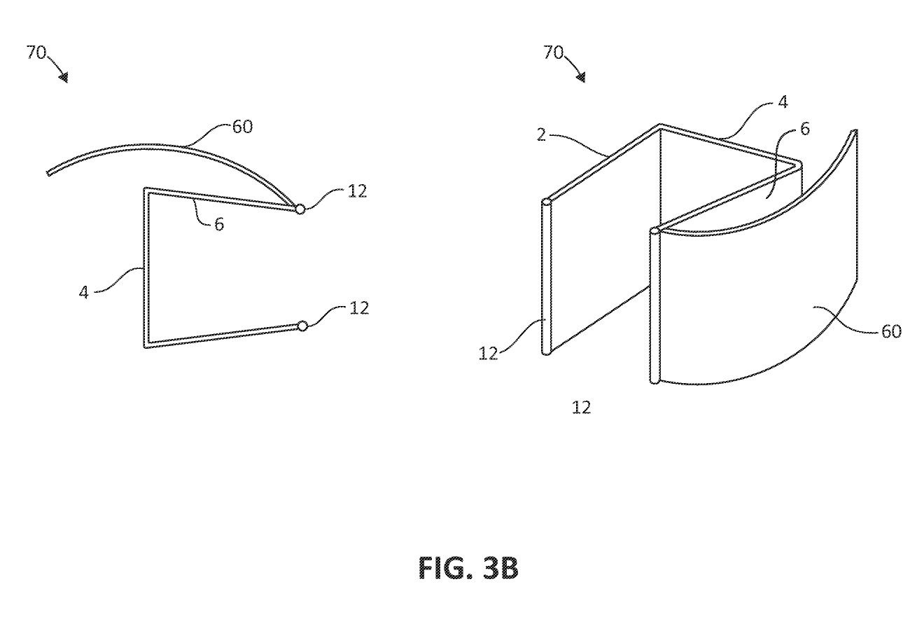

Turning to FIG. 3A, depicts more clearly the pivot structure 10 and another exemplary embodiment of a pivot structure 30. FIG. 3. depicts an exemplary embodiment where the pivot structure 10 and 30, or more specifically, the hinge structure 8, is connected to at least one elongated member 28. The elongated member 28 has at least two ends, a first end and a second end. The first end may connect either to the pivot structure 10, or more preferably, to the hinge structure 8. The second end may then connect to the cushion structure 11 for additional support and strength.

The elongated member 28 may be placed parallel to, angled towards, or angled away from another elongated member 28. The elongated member 28 may be connected permanently or semi-permanently to the pivot structure 10 or hinge structure 8 and are used to connect the pivot structure 10 or hinge structure 8 to the cushion structure 11. The connecting the pivot structure 10 or hinge structure 8 to the cushion structure 11 may include, but are not limited to adhesive, tape, any welding technique, clamps, screws, pins, bolts, or any other known adhesive commonly known in the art suitable for such purposes. The elongated member 28 may be of any shape or size depending upon the shape or size of the cushion structure 11. For example, the elongated member 28 may be curved and connected inside of a C-shape cushion structure 11 and the elongated member 28 being inserted into and spanning the length of the cushion structure 11 for additional support and stability. The elongated member 28 connecting to the pivot structure 10 or hinge structure 8 provides a useful option for supporting the cushion structure 11 and durability for the pivot structure 10.

In one exemplary embodiment, the pivot structure 30 includes a hinge structure 8 and the pivot structure 30 having two sides; a first side 24 and a second side 22. The two sides form a connection on one of the ends of each of the first side 24 and the second side 22 to form a mounting structure to attach to a door. In FIG. 3, one exemplary embodiment of the pivot structure 30 depicts a three dimensional view in a V-shape or L-shape configuration. Each of the pivot structure 30 sides may include a n-number of openings allowing for any type of pin, screw, nail, bolt, or fastener known in the art, which are suitable for such an application, to be inserted into the hole and connect to the door. At one of the ends of both the first side 24 and the second side 22, a protective device 12 may be attached to protect the surface of the door from being scratched or damaged. FIG. 3 depicts the hinge structure 8 connecting to the ends of the first side 24 to the second side 22. The protective device 12 is attached to the opposite end of the first side 24 and the second side 22. The protective device 12 may be any type of rubber, plastic, foam, fibrous substance, cloth, synthetic material, or any other type of protective device for surface protection known in the art, which are suitable for such an application.

The pivot structure 30, may attach to both the cushion structure 11 using both permanent and semi-permanent options; including, but not limited to screws, nails, pins, glue, tape, Velcro®, or other type adhesive devices. The pivot structure 30 may connect to the hinge structure 8. The hinge structure 8 may be connected and joined directly to one of the ends the first side 24 or one of the ends of the second side 22. By placing the hinge structure 8 at the end of the first side 24 and one of the ends of the second side 22, both the first side 24 and the second side 22 are free to pivotally move about the hinge structure 8. FIG. 3 depicts the pivot structure 30 showing the connection of the first side 24 and the second side 22 as a V-shaped pivot structure. Additionally, the hinge structure 8 could easily be attached to any location on any of the two sides, if needed. Depending upon the way a door opens, either swinging to the outside or the inside, the hinge structure 8, is capable of being connected to the particular side of the pivot structure 30 to insure any useful option for positioning of the cushion structure 11. The hinge structure 8 may be one commonly known in the art allowing both the pivot structure 30 and the cushion structure 11 to pivotally move about the hinge structure 8. The hinge structure 8 may also include the elongated member 28 for additional support and durability to connect to the cushion structure 11. The first side 24 or the second side 22 may connect directly to the cushion structure 11 with the first side 24 or the second side 22 being connected directly to the planar end 18. Additional features, as described in earlier figures, are also depicted as illustrated examples.

Turning to FIG. 3B, an exemplary embodiment is depicted from the top view and a three-dimensional view of a pivot structure 70 with the connection piece 60. In one embodiment, the connection piece 60 and the pivot structure 70 may be one single piece entity. The connection member 60 may have two ends; a first end being connected to the end of either the first side 2 or the third side 6 and a second end for connecting to the cushion structure 11. A seen from both the top view and the three-dimensional view, the connection piece 60 may include the protective device 12 to cover any edge that may be exposed. The protective device 12 may be of various sizes and shapes to prevent injury to persons or any damage or scratching to the surface upon which the pivot structure is attached. The protective device 12 may be removed with ease and is only optional for the pivot structure 70.

The connection member 60 may be designed in any particular shape according to the door or doorframe the pivot structure 70 will attach to or protect. In the depicted example, the connection piece 60 is elliptical or parabolic shape with the first end connected to the end of the third side 6. The second end is positioned so that a cushion structure 11 may be connected to the connection piece 60. The pivot structure 70 includes the connection piece 60 and is one single entity. For example, when the pivot structure 70 is attached to a door and the door is closed, the connection piece 60, which is connected to the cushion structure 11, rotates backwards, or away from the third side 6. The connection piece 60 maintains a constant pressure on the cushion structure 11. Upon the opening of the door, the spring like pressure in the connection piece 60, releases or springs the cushion structure 11 into a position to prevent the door, which the pivot structure is attached, from closing leaving a space between the door and another door or door frame. Additional features, as described in earlier figures, are also depicted as illustrated examples.

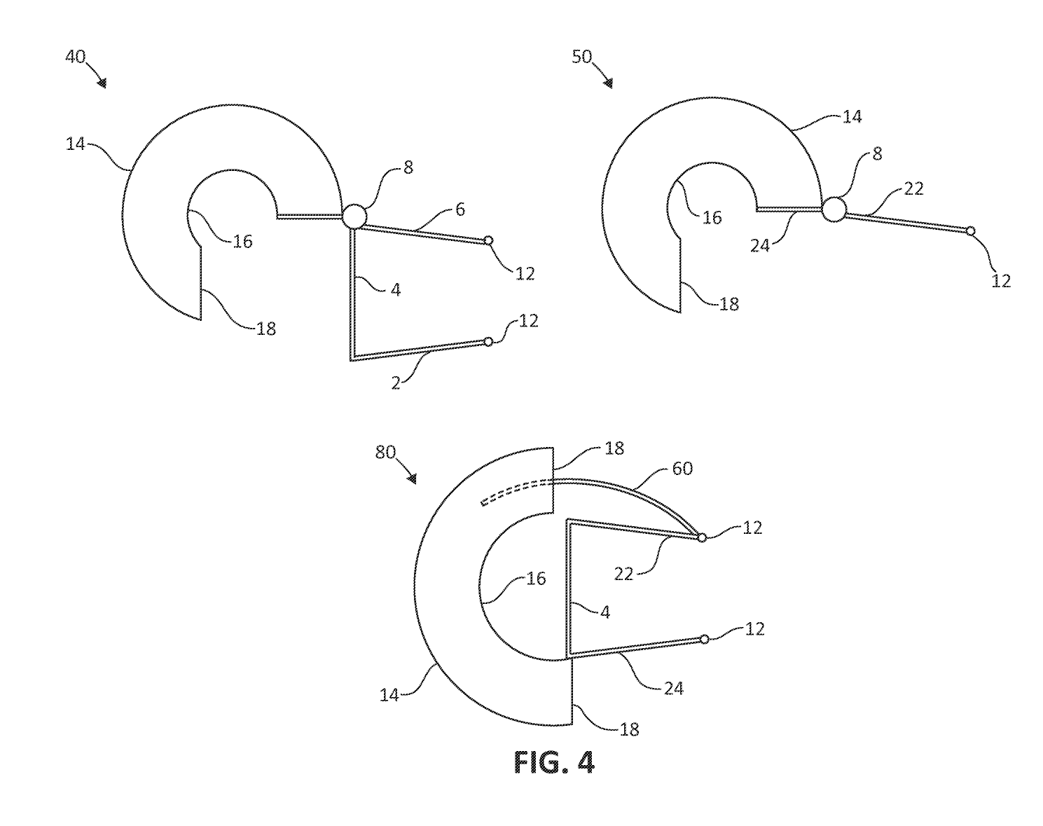

Turning to FIG. 4, an exemplary embodiment is depicted from the top view of a door safety device 40, 50, and 80 assembled together with the cushion structure 11 and pivot structure 10 and 70. The assembled door safety device 40 illustrates from a top view the top portion of the cushion structure 11 with one of the corner sections of the planar surface 18 of the cushion structure 11 connected to the hinge structure 8. As illustrated from the top view, the hinge structure 8 is a common link between the three-sided pivot structure 10 and the cushion structure 11. Both the cushion structure 11 and the pivot structure 10 are free to pivotally rotate about the hinge structure 8. Additional features, as described in earlier figures, are also depicted as illustrated examples.

In another exemplary embodiment, a top view illustrates a door safety device 50 assembled together with the cushion structure 11 and the pivot structure 30. The assembled door safety device 50 illustrates from a top position showing the top portion of the cushion structure 11 with one of the corner sections of the planar surface 18 of the cushion structure 11 connected to the hinge structure 8. The first side 24 of the pivot structure 30 is connected to the planar surface 18 of the cushion structure 11. As illustrated from the top view, the hinge structure 8 is the common link between the two-sided pivot structure 30 and the cushion structure 11. Both the cushion structure 11 and the pivot structure 30 are free to pivotally rotate about the hinge structure 8. Additional features, as described in earlier figures, are also depicted as illustrated examples.

In another exemplary embodiment, a top view illustrates the door safety device 80 assembled together with the cushion structure 11 and the pivot structure 70. In the depicted example, the door safety device 80 is showing the position of the cushion structure upon the opening of the door, the spring like pressure in the connection piece 60 releases or springs the cushion structure 11 into a position to prevent the door, which the pivot structure is attached, from closing leaving a space between the door and another door or door frame. Additional features, as described in earlier figures, are also depicted as illustrated examples.

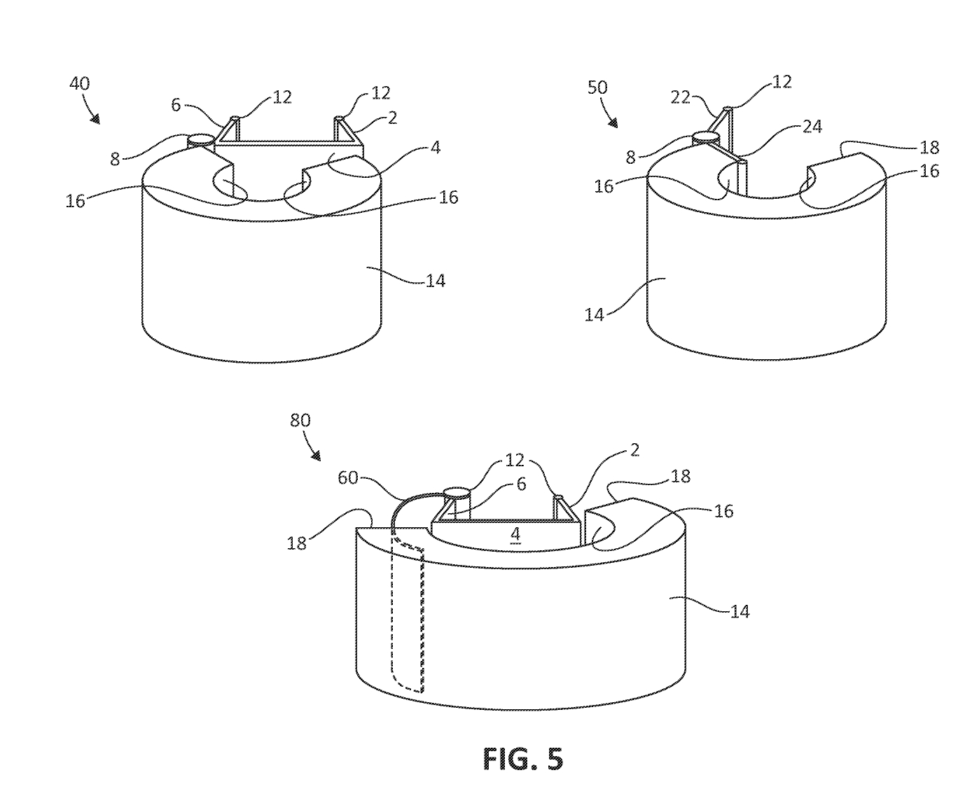

Turning to FIG. 5, an exemplary embodiment depicts a three dimensional view from the back view of a door safety device 40 assembled together with the cushion structure 11 and the pivot structure 10. The assembled door safety device 40 illustrates a three dimensional view from the back position highlighting the outer surface 14 portion of the cushion structure 11. As depicted in this example, the planar surface 18 on the left side of the cushion structure 11 is connected to the hinge structure 8. As illustrated from the back view, the hinge structure 8 is the common link between the three-sided pivot structure 10 and the cushion structure 11. Further illustrated from the back view is a depiction of the second side 4 of the pivot structure 10 connecting to the hinge structure 8. The left end of the second side 4 connects to the hinge structure 8 with the third side 6 of the pivot structure 10 also being connected to the hinge structure 8. Both the cushion structure 11 and the pivot structure 10 are free to pivotally rotate about the hinge structure 8. Additional features, as described in earlier figures, are also depicted as illustrated examples.

FIG. 5 also depicts an exemplary embodiment in a three dimensional view from the back view of a door safety device 50 assembled together with the cushion structure 11 and the pivot structure 30. The assembled door safety device 50 illustrates a three dimensional view from the back position highlighting the outer surface 14 portion of the cushion structure 11. As depicted in this example, the planar surface 18 on the left side of the cushion structure 11 is connected to the hinge structure 8. As illustrated from the back view, the hinge structure 8 is the common link between the three-sided pivot structure 10 and the cushion structure 11. Further illustrated from the back view is a depiction of the first side 24 of the pivot structure 30 connecting to the hinge structure 8. The left end of the first side 24 connects to the hinge structure 8 with the second side 22 of the pivot structure 30 also being connected to the hinge structure 8. Both the cushion structure 11 and the pivot structure 30 are free to pivotally rotate about the hinge structure 8. Additional features as described in earlier figures are also depicted as illustrated examples.

FIG. 5 also depicts and exemplary embodiment in a three-dimensional view from the back view of the door safety device 80 with the cushion structure 11 and the pivot structure 70. In the depicted example, the door safety device 80 is showing the position of the cushion structure 11 upon the opening of the door, the spring like pressure in the connection piece 60 releases or springs the cushion structure 11 into a position to prevent a door, which the pivot structure is attached, from closing leaving a space between the door and another door or door frame. Additional features, as described in earlier figures, are also depicted as illustrated examples.

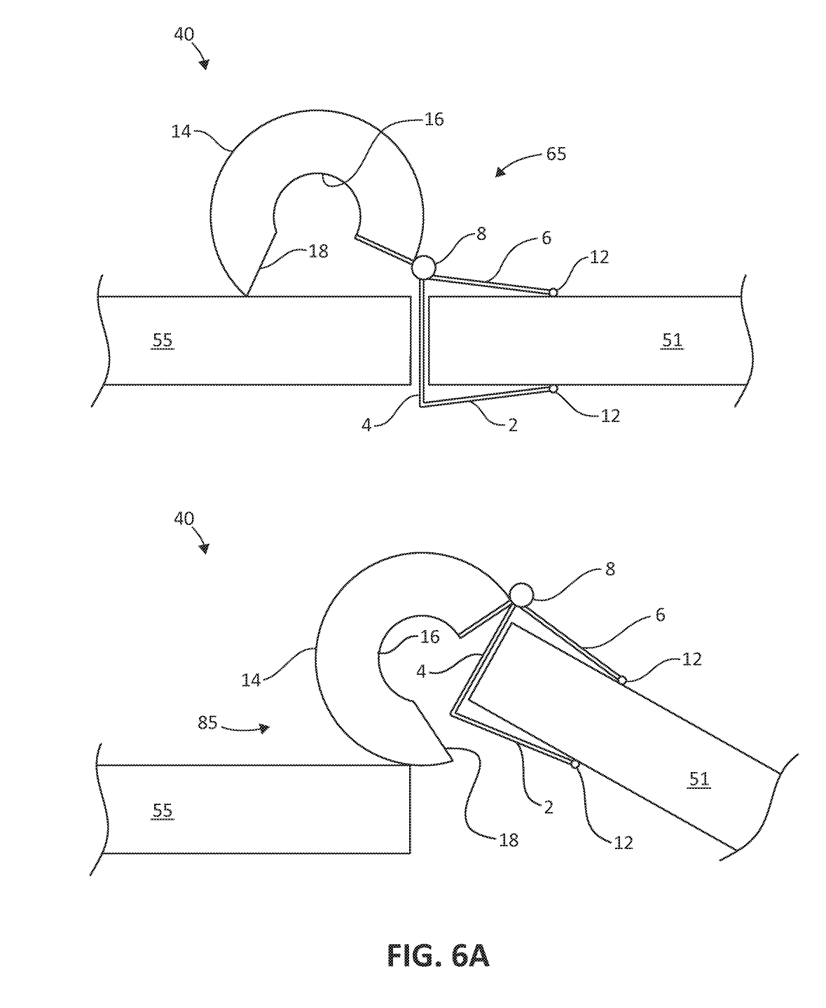

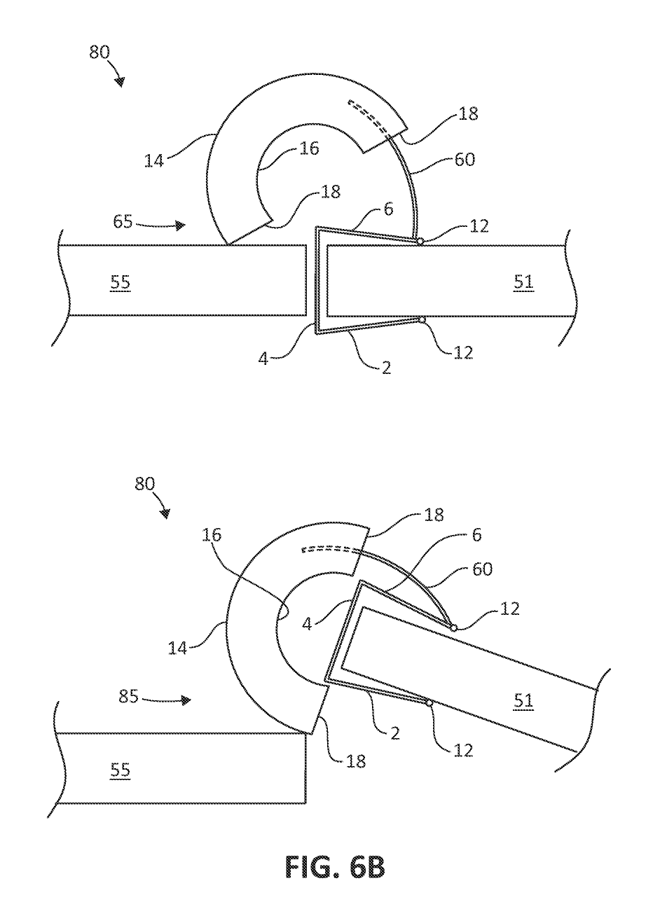

Turning to FIG. 6A a three dimensional view of one embodiment of a door safety device 40 assembled onto a door 51 is depicted together with the cushion structure 11 being connected to the three-sided pivot structure 10. The embodiment illustrates the door safety device 40 in a set position 65 and then upon the opening of the door, the door safety device 40 is released to the safety position 85.

In the depicted embodiment the door safety device 40 is illustrated from with the three-sided pivot structure 10. The first side 2 and the third side 6 is connected onto the door 51 with the first side 2 and the third side 6 each containing a protective device 12 protecting the door 51 from scratches or other damage caused by the pivot structure 10. The first side 2 and the third side 6 maintain sufficient pressure on the door 51 or adjacent door or door frame. Although the pivot structure 10 has been shown to be semi-permanently clamped onto the door 51, any joining or connecting method which is known in the art can be used to couple the pivot structure 10 to the door 51.

In the depicted embodiment, the hinge structure 8 is a spring-loaded hinge and is connected to corner of the pivot structure 10, where the third side 6 connects to the second side 4. The hinge structure 8 is connected to the edge of the planar surface 18 where the hinge structure 8 connects to the outer surface 14 of the cushion structure 11. In operation, the door 51 may first be in a closed position, or a set position 65, without the cushion structure 11 preventing the door 51 from closing. For example, in the set position 65, the cushion structure 11 may be in a resting state on the door 51 or adjacent door or doorframe. The cushion structure 11 may be pivotally oriented away from the door being held in a set position 65 or neutral position. The neutral position is positioned similarly to the set position 65 as shown in FIG. 6A, but depending on the type of spring-loaded hinge or other type of hinge commonly known in the art, the door safety device 40 may not be armed to release the door safety device. The neutral position provides the flexibility to maintain the connection of the door safety device 40 to the door 51 without the door safety device 40 being operable for preventing the door from closing.

The set position 65 may be oriented away from the door at varying angles depending upon the hinge structure 8 designs and flexibility. The door safety device 40 may be positioned to the set position 65 by pulling back on the door safety device 40 and setting or arming the hinge structure 8 to release the door safety device 40 upon the opening of the door 51. As illustrated in FIG. 6, when the door 51 is opened the door safety device 40 is armed and positioned to the set position 65, the door safety device is released to a safety position 85, as shown by the direction of the arrows. With the door safety device 40 in the safety position 85, the cushion structure 11 is oriented around the door 51 preventing the door 51 from substantially closing. The inner surface 16 of the cushion structure 11, depending upon the shape or size used along with the mounting options chosen for the pivot structure 10, may touch and come into contact with the door 51, or may be free of any contact with the door 51, depending upon the shape of cushion structure 11 being utilized. The outer surface 14, is positioned to come into contact with a doorframe surface, a surface of another or additional door, or any other object that would prevent the door 51 to from closing. The cushion structure 11 would absorb the impact of the closing door 51. The cushion structure 11 would create a gap in between the closing door 51 and a doorframe or another door thereby preventing a body part, particularly a finger, from being in between the closing door 51 and the doorframe or an additional door. The gap created by the cushion structure for preventing the door from substantially closing, in one exemplary embodiment, may be at least 1 inch.

Turning to FIG. 6B a three dimensional view of one embodiment of a door safety device 80 assembled onto a door 51 is depicted together with the cushion structure 11 being connected to the three-sided pivot structure 70. The embodiment illustrates the door safety device 80 in a set position and then upon the opening of the door, the door safety device 40 is released to the safety position 85.

In the depicted embodiment, the connection piece 60, may flex, bend, or rotate away from the third side 6. The connection piece 60 maintains a constant pressure upon the cushion structure 11 when the connection piece 60 is flexed, bent, rotated, or positioned away from the first side 6. The connection piece 60 is similar to a spring and will spring back to the safety position 85. For example, when the pivot structure 70 is attached to a door and the door is closed, the connection piece 60, which is connected to the cushion structure 11, rotates backwards, or away from the third side 6 and is in the safety position 60. The connection piece 60 maintains constant pressure on the cushion structure 11. Upon the opening of the door, the spring like pressure in the connection piece 60 releases or springs the cushion structure 11 into a position to prevent the door, which the pivot structure is attached, from closing leaving a space between the door 51 and another door or doorframe.

The set position 65 may be oriented away from the door 51 at varying angles depending upon connection piece 60 designs and flexibility. The door safety device 40 may be positioned to the set position 60 by pulling back on the door safety device 40 and setting or arming the hinge structure 8 to release the door safety device 40 upon the opening of the door 51. As illustrated in FIG. 6B, when the door 51 is opened the door safety device 40 is armed and positioned to the set position 60, the door safety device is released to a safety position 85.

With the door safety device 40 in the safety position 85, the cushion structure 11 is oriented around the door 51 for preventing the door 51 from substantially closing. The inner surface 16 of the cushion structure 11, depending upon the shape or size used along with the mounting options chosen for the pivot structure 10, may completely touch and come into contact with the door 51, or may be free of any contact with the door 51, depending upon the shape of cushion structure 11 being utilized. The outer surface 14 is positioned to come into contact with a doorframe surface, a surface of another or additional door, or any other object that would allow for the door 51 to close. The cushion structure 11 would absorb the impact of the closing door 51. The cushion structure 11 would create a gap in between the closing door 51 and a doorframe or another door thereby preventing a body part, particularly a finger, from being in between the closing door 51 and a doorframe or an additional door. The gap created by the cushion structure for preventing the door 51 from substantially closing, in one exemplary embodiment, may be at least 1 inch.

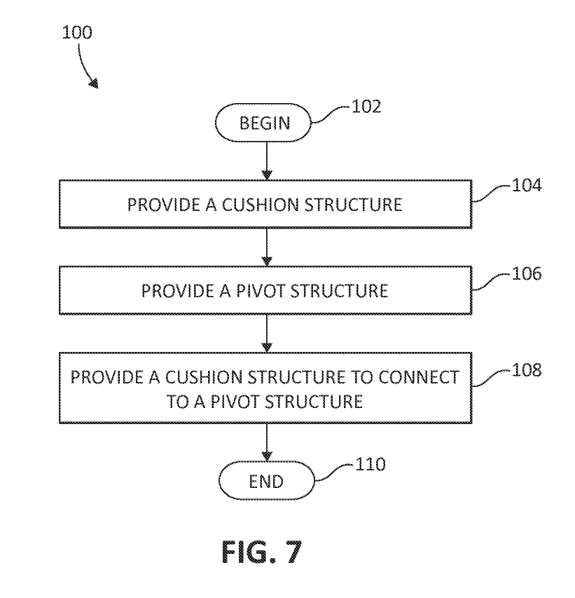

FIG. 7 depicts one exemplary method 100 of manufacturing a door safety device for preventing a door from substantially closing. The method 100 begins (step 102) with providing a cushion structure (step 104). A pivot structure is provided (step 106). The method 100 then ends (step 110).

While one or more embodiments of the present invention have been illustrated in detail, the skilled artisan will appreciate that modifications and adaptations to those embodiments may be made without departing from the scope of the present invention as set forth in the following claims.

What is claimed is:

1. A device for preventing the closing of a door, comprising:
a cushion structure; and
a pivot structure connected to the cushion structure, the pivot structure being adapted to connect to the door, wherein the pivot structure is adapted to position the cushion structure in a manner to prevent the door from substantially closing.

2. The device of claim 1, wherein the pivot structure is a hinge adapted to perform one of:
retain the cushion structure in a set position when the door is closed, and
when the door is opened, release the cushion structure from the set position into a safety position to prevent the door from substantially closing.

3. The device of claim 2, wherein the hinge is further adapted to retain the cushion structure in the safety position to prevent the door from substantially closing.

4. The device of claim 1, wherein the pivot structure is adapted to couple to at least one elongated member, the at least one elongated member substantially perpendicular to the pivot structure, wherein the at least one elongated member having a first end and a second end, the first end being connected to the pivot structure and the second end being connected to the cushion structure.

5. The device of claim 1, wherein the pivot structure at least semi-permanently connects to the door and to the cushion structure.

6. The device of claim 1, wherein the cushion structure incorporates one of a dense polyvinyl chloride (PVC) material, a polyurethane material, a metallic material, and a joint metallic and polyurethane material.

7. The device of claim 1, wherein the cushion structure is adapted to resist substantial compression to prevent the door from substantially closing.

8. A device for preventing the closing of a door, comprising:
a cushion structure including a outer surface, a inner surface, and a substantially planar end there between, wherein the inner surface is adapted to come into contact with a door surface, and the outer surface is adapted to come into contact with one of a door frame surface and a surface of an additional door; and
a pivot structure having a first side, a second side, and a third side, the first side and the third side being adapted to secure the pivot structure onto a door, with the pivot structure being pivotally attached between one of the first side and the second side and the second side and the third side to the substantially end of the cushion structure, the pivot structure adapted to position the cushion structure in a manner to prevent the door from substantially closing.

9. The device of claim 8, wherein the pivot structure includes a spring-loaded retractable hinge, the spring-loaded retractable hinge adapted to release the cushion structure into a safety position when the door is opened to prevent the door from substantially closing.

10. The device of claim 9, wherein the hinge is adapted to retain the cushion structure in a safety position to prevent the door from substantially closing.

11. The device of claim 8, the cushion structure incorporates one of a dense polyvinyl chloride (PVC) material, a polyurethane material, a metallic material, and a joint metallic and polyurethane material, the cushion structure adapted to resist substantial compression to prevent the door from substantially closing.

12. The device of claim 8, the cushion structure incorporates one of a internal weighted lining and a external weighted lining to provide structural support.

13. The device of claim 8, wherein the pivot structure is adapted to insert a plurality of elongated member perpendicular to the pivot structure, the elongated member having a first end and a second end, the first end being connected to the substantially U-shaped pivot structure and the second end being inserted into the cushion structure.

14. A method of manufacturing a device for preventing the closing of a door, comprising:
providing a cushion structure; and
providing a pivot structure connected to the cushion structure, the pivot structure being adapted to connect to the door, wherein the pivot structure is adapted to position the cushion structure in a manner to prevent the door from substantially closing.

15. The method of claim 14, wherein providing the pivot structure providing a hinge adapted to perform one of:
retain the cushion structure in a set position when the door is closed, and
when the door is opened, release the cushion structure from the set position into a safety position to prevent the door from substantially closing.

16. The method of claim 15, wherein providing the hinge including providing the hinge further adapted to retain the cushion structure in the safety position to prevent the door from substantially closing.

17. The method of claim 14, wherein providing the pivot structure providing the pivot structure is adapted to couple to at least one elongated member, the at least one elongated member substantially perpendicular to the pivot structure, wherein the at least one elongated member having a first end and a second end, the first end being connected to the pivot structure and the second end being connected to the cushion structure.

18. The method of claim 14, wherein providing the pivot structure including providing the pivot structure at least semi-permanently connects to the door and to the cushion structure.

19. The method of claim 14, wherein providing the cushion structure including providing the cushion structure incorporates one of a dense polyvinyl chloride (PVC) material, a polyurethane material, a metallic material, and a joint metallic and polyurethane material.

20. The method of claim 14, wherein providing the cushion structure including providing the cushion structure is adapted to resist substantial compression to prevent the door from substantially closing.
